(19) United States
(12) Patent Application Publication
(10) Pub. No.: US 2011/0136013 A1
(43) Pub. Date: Jun. 9, 2011

(54) Material for coating a positive electrode of a lithium-ion battery and a method for making the same

(75) Inventors: Na Liu, Dongguan (CN); Meng-Yao Wu, Dongguan (CN); Lei-Min Xu, Dongguan (CN); Lu Li, Dongguan (CN); Rui Xu, Dongguan (CN); Feng-Gang Zhao, Dongguan (CN)

(73) Assignee: Dongguan Amperex Technology Co., Ltd.

(21) Appl. No.: 12/591,961

(22) Filed: Dec. 7, 2009

(51) Int. Cl. H01M 4/58; B05D 5/12; C01G 25/02; C01G 19/02; C01F 7/02; C01F 5/02; C01B 33/12; C01F 17/00; C01G 9/02

(52) U.S. Cl. 429/231.8; 427/126.3; 423/608; 423/618; 423/625; 423/635; 423/335; 423/263; 423/622

(57) ABSTRACT

A method is disclosed for coating a positive active material of a lithium-ion battery. The method includes the step of dissolving at least one salt that contains a coating metal in a solvent to provide a solution, the step of dissolving a lithium-containing positive active material in the solution and adjusting the pH value of the solution to deposit M(OH)₂ₙ on the lithium-containing positive active material, the step of drying the M(OH)₂ₙ and the lithium-containing positive active material, and the step of sintering the M(OH)₂ₙ and the lithium-containing positive active material to coat the lithium-containing positive active material with MOₙ.

### BACKGROUND OF INVENTION

1. Field of Invention

The present invention relates to a material for coating a positive electrode of a lithium-ion battery and method for making the same.

2. Related Prior Art

As people look for smaller, lighter cell phones, digital cameras, laptop computers and other electronic devices, they need lithium-ion batteries with higher energy densities, better safety performances and longer lives.

A lithium-ion battery includes a positive electrode, a negative electrode, an isolating membrane located between the positive and negative electrodes and electrolyte. The positive electrode includes a positive liquid collector and a positive active material provided on the positive liquid collector. The negative electrode includes a negative liquid collector and a negative active material provided on the negative liquid collector. The positive active material is selected from LiCoO₂ and LiNiO₂ with a layered structure and LiMn₂O₄ and LiNiCoMnO₂ with a crystal structure.

There are however problems with the foregoing positive active materials. Voltage for charging LiCoO₂ cannot exceed 4.2 volts. The structure of LiNiO₂ is unstable. The high-temperature performance of LiMn₂O₄ is poor. The voltage platform of LiNiCoMnO₂ is low. Therefore, these positive active materials must be modified. The most effective approach for modification is to coat these positive active materials. By evenly providing a limited amount of oxide on the positive active materials, the structures of the positive active materials are improved without compromising their specific capacities, and their reaction with the electrolyte is avoided. Hence, their energy densities, safety performances and recharging-discharging stabilities are improved.

As disclosed in U.S. Pat. No. 7,445,871 issued on 4 Nov. 2008, a coating material, in the form of liquid, is provided on the positive active material. The coating material and the positive active material are sintered. The positive active material is therefore coated with the coating material. However, the resultant coating is not even. Hence, the energy density, safety performance and recharging-discharging stability are not satisfactory.

The present invention is therefore intended to obviate or at least alleviate the problems encountered in prior art.

### SUMMARY OF INVENTION

It is an objective of the present invention to provide a method for coating a positive active material of a lithium-ion battery to provide the positive active material with excellent energy density, safety performance and stability of recharge/discharge cycles.

To achieve the foregoing objective, the method includes the step of dissolving at least one salt that contains a coating metal in a solvent to provide a solution, the step of dissolving a lithium-containing positive active material in the solution and adjusting the pH value of the solution to deposit M(OH)₂ₙ on the lithium-containing positive active material, the step of drying the M(OH)₂ₙ and the lithium-containing positive active material, and the step of sintering the M(OH)₂ₙ and the lithium-containing positive active material to coat the lithium-containing positive active material with MOₙ.

The present invention takes advantages of a liquid method and a solid method to provide the positive active material with an even coating without compromising the specific capacity.

In the step of dissolving the salt in the solvent, the solvent is selected from a group consisting of water, an organic solvent that can be mixed with water, and mixture of organic solvents that can be mixed with water.

The solvent is an organic solvent that can be mixed with water. The ratio of the weight of the organic solvent over the weight of the water is 0:1 to 100:1. The weight of the solvent is 0.1 to 20 times as much as the weight of the salt.

The solvent is selected from a group consisting of alcohol and ketone.

The step of dissolving the salt in the solvent lasts for 0.5 to 1 hour at 0 to 100 degrees Celsius.

In the step of dissolving a lithium-containing positive active material in the solution and adjusting the pH value of the solution, the pH value is 3 to 12, and the deposition takes 1 to 20 hours.

In the step of drying the M(OH)₂ₙ and the lithium-containing positive active material, the temperature is 50 to 200 degrees Celsius, and the drying takes 1 to 20 hours.

In the step of sintering the M(OH)₂ₙ and the lithium-containing positive active material, the sintering is executed at 300 to 1300 degrees Celsius, and the sintering takes 1 to 20 hours.

The method further includes the step of using the solvent to wash the lithium-containing positive active material to which the M(OH)₂ₙ is adhered before the step of drying the M(OH)₂ₙ and the lithium-containing positive active material.

The lithium-containing positive active material is LiCo_{1-x-y}M′ₓM″_{y}O₂, wherein M′ and M″ are selected from a group consisting of Al, Ce, Ga, Ge, La, Mg, Mn, Ni, Si, Sn, Ti, W and Zn, and 0≦x<1, and 0≦y<1.

In the step of sintering the M(OH)₂ₙ and the lithium-containing positive active material to coat the lithium-containing positive active material with MOₙ, the M of the MOₙ is selected from a group consisting of Al, Ce, La, Mg, Si, Sn, Ti, Zn and Zr.

The salt that contains the coating metal is selected from a group consisting of non-organic salts, alcohols and organic salts.

The ratio of the weight of the salt that contains the coating material over the weight of the lithium-containing positive active material is 0.1% to 60%.

It is another objective of the present invention to provide an effective material for coating a positive active material of a lithium-ion battery.

To achieve the foregoing objective, the coating material is made according the above-mentioned method.

It is the primary objective of the present invention to provide an efficient lithium-ion battery.

To achieve the foregoing objective, the lithium-ion battery includes a positive electrode, a negative electrode, an isolating membrane provided between the positive and negative electrodes, and electrolyte. The positive electrode is made by mixing conductive carbon powder and adhesive with the positive active material made according to the above-mentioned method.

Other objectives, advantages and features of the present invention will become apparent from the following description referring to the attached drawings.

### BRIEF DESCRIPTION OF DRAWINGS

The present invention will be described via detailed illustration of embodiments referring to the drawings wherein:

FIG. 1 is an enlarged SEM photograph of LiCoO₂;

FIG. 2 is another enlarged SEM photograph of LiCoO₂;

FIG. 3 is an enlarged SEM photograph of LiCoO₂ coated with ZrOₙ according to the first embodiment of the present invention;

FIG. 4 is another enlarged SEM photograph of LiCoO₂ coated with ZrOₙ according to the first embodiment of the present invention;

FIG. 5 is a chart of discharge specific capacity versus life length of LiCoO₂ of a hemi-battery with lithium as a negative electrode at 3.0 to 4.5 volts, at 0.2 C before and after it is coated with ZrOₙ according to the first embodiment of the present invention;

FIG. 6 is a chart of discharge specific capacity versus life length of LiCoO₂ of a hemi-battery with lithium as a negative electrode at 3.0 to 4.5 volts, at 0.2 C before and after it is coated with ZnOₙ according to the second embodiment of the present invention;

FIG. 7 is a chart of discharge specific capacity versus life length of LiNi_{0.8}Co_{0.2}O₂ of a hemi-battery with lithium as a negative electrode at 3.0 to 4.3 volts, at 0.2 C before and after it is coated with TiOₙ according to the third embodiment of the present invention;

FIG. 8 is a chart of discharge specific capacity versus life length of LiNi_{0.8}Co_{0.2}O₂ of a hemi-battery with lithium as a negative electrode at 3.0 to 4.3 volts, at 0.2 C before and after it is coated with SnOₙ according to the fourth embodiment of the present invention;

FIG. 9 is a chart of discharge specific capacity versus life length of LiNi_{1/3}Co_{1/3}Mn_{1/3}O₂ of a hemi-battery with lithium as a negative electrode at 3.0 to 4.5 volts, at 0.2 C before and after it is coated with SnOₙ according to the fifth embodiment of the present invention;

FIG. 10 is a chart of discharge specific capacity versus life length of LiNi_{0.5}Co_{0.2}Mn_{0.3}O₂ of a hemi-battery with lithium as a negative electrode at 3.0 to 4.5 volts, at 0.2 C before and after it is coated with MgOₙ according to the sixth embodiment of the present invention;

FIG. 11 is a chart of discharge specific capacity versus life length of LiNi_{0.8}Co_{0.2}O₂ of a hemi-battery with lithium as a negative electrode at 3.0 to 4.3 volts, at 0.2 C before and after it is coated with LaOₙ according to the seventh embodiment of the present invention;

FIG. 12 is a chart of discharge specific capacity versus life length of LiNi_{0.8}Co_{0.2}O₂ of a hemi-battery with lithium as a negative electrode at 3.0 to 4.3 volts, at 0.2 C before and after it is coated with CeOₙ according to the eighth embodiment of the present invention;

FIG. 13 is a chart of discharge specific capacity versus life length of LiCoO₂ of a hemi-battery with lithium as a negative electrode at 3.0 to 4.5 volts, at 0.2 C before and after it is coated with AlOₙ according to the ninth embodiment of the present invention;

FIG. 14 is a chart of discharge specific capacity versus life length of LiCoO₂ of a hemi-battery with lithium as a negative electrode at 3.0 to 4.5 volts, at 0.2 C before and after it is coated with AlZrOₙ according to the tenth embodiment of the present invention; and

FIG. 15 is a chart of capacity rate versus life length of a positive material of a battery with artificial graphite as a negative electrode at 3.0 to 4.5 volts, at 0.2 C before and after it is coated according to the eleventh embodiment of the present invention.

### DETAILED DESCRIPTION OF EMBODIMENTS

Referring to the drawings, a material for coating a positive electrode of a lithium-ion battery and method for making the same according to the present invention will be described. In the following description, the term “coating ratio” refers to a ratio of the weight of oxide over the weight of an active material coated with the oxide multiplied by 100%.

In a first embodiment, 23 grams of K₂ZrFO₆ is dissolved in 2 litters of de-ionized water. At the room temperature, the solution is stirred to expedite the dissolution. 500 grams of LiCoO₂ is added to the solution and the solution is stirred. 2M of aqua ammonia is dripped into the solution to adjust the pH value of the solution to 7, and the solution is stirred for 5 hours. The stirring is stopped before filtering and washing are executed. Drying is conducted at 85 degrees Celsius to produce a mixture. The mixture is sintered at 1000 degrees Celsius for 2 hours before it is cooled at the room temperature. Finally, a coated positive active material is provided with a coating ratio of 3%.

The coated positive active material is mixed with conductive carbon and polyvinylidene fluoride (“PVDF”) to produce positive slurry. The positive slurry is coated on a positive liquid collector to produce a positive electrode. A lithium plate is used as a negative electrode. The positive and negative electrodes are assembled to produce a battery in a clean box.

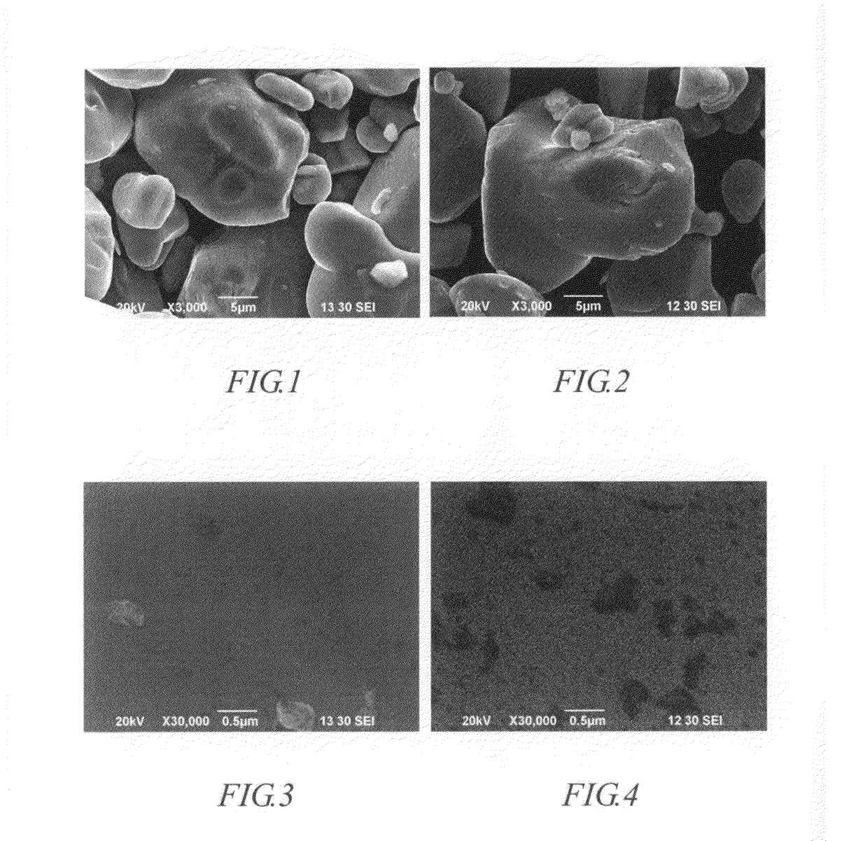

Referring to FIGS. 1 and 2, there is shown the LiCoO₂ before the coating. In FIG. 1, the LiCoO₂ is enlarged by 3000 times. In FIG. 2, the LiCoO₂ is enlarged by 30000 times.

Referring to FIGS. 3 and 4, the LiCoO₂ coated with the ZrOₙ is shown. In FIG. 3, the LiCoO₂ coated with the ZrOₙ is enlarged by 3000 times. In FIG. 4, the LiCoO₂ coated with ZrOₙ is enlarged by 30000 times. The LiCoO₂ in a darker color is evenly coated with the ZrOₙ in a lighter color.

FIG. 5 is a chart of the discharge specific capacity versus the life length of the LiCoO₂ at 3.0 to 4.5 volts, at 0.2 C before and after it is coated with the ZrOₙ. The discharge specific capacity of the LiCoO₂ is increased by 5.5 mAh/g after the coating.

In a second embodiment, 55 grams of Zn(NO₃)₂.6H₂O is dissolved in 2 litters of de-ionized water. At the room temperature, the solution is stirred to expedite the dissolution. 500 grams of LiCoO₂ is added to the solution and the solution is stirred. 2M of aqua ammonia is dripped into the solution to adjust the pH value of the solution to 8, and the solution is stirred for 5 hours. The stirring is stopped before filtering and washing are executed. Drying is conducted at 85 degrees Celsius to produce a mixture. The mixture is sintered at 600 degrees Celsius for 2 hours before it is cooled at the room temperature. The coated positive active material is provided with a coating ratio of 3%.

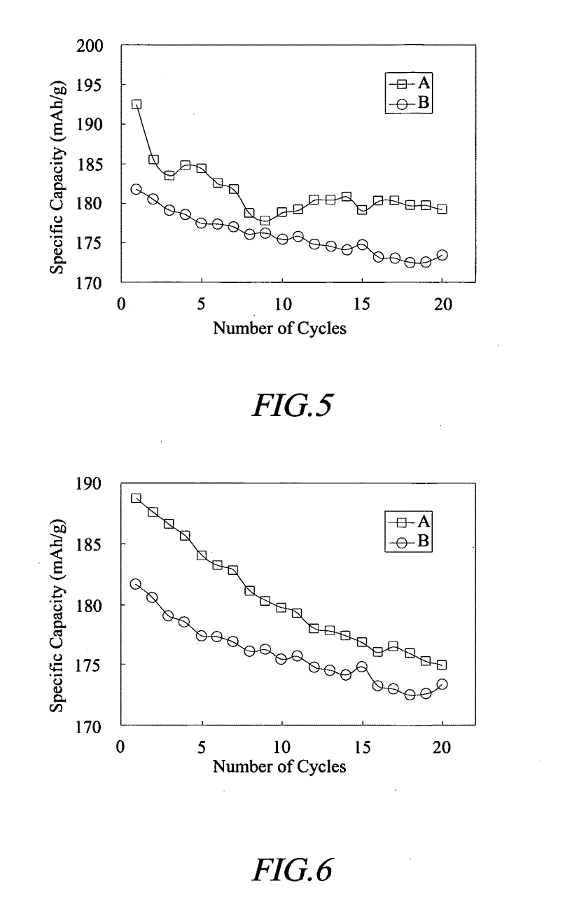

The coated positive active material is mixed with conductive carbon and polyvinylidene fluoride (“PVDF”) to produce positive slurry. The positive slurry is coated on a positive liquid collector to produce a positive electrode. A lithium plate is used as a negative electrode. The electrodes are assembled to produce a battery in a clean box. Referring to FIG. 6, at 3.0 to 4.5 volts, at 0.2 C, the discharge specific capacity of the LiCoO₂ is considerably increased after it is coated with ZnOₙ.

In a third embodiment, 36 grams of dimethyl titanate is dissolved in 0.5 litter of ethanol. At the room temperature, the solution is stirred to expedite the dissolution. 500 grams of LiNi_{0.8}Co_{0.2}O₂ is added to the solution and the solution is stirred. The solution is stirred for 5 hours. The stirring is stopped before filtering and washing are executed. Drying is conducted at 90 degrees Celsius to produce a mixture. The mixture is sintered at 500 degrees Celsius for 5 hours before it is cooled at the room temperature. The coated positive active material is provided with a coating ratio of 3%.

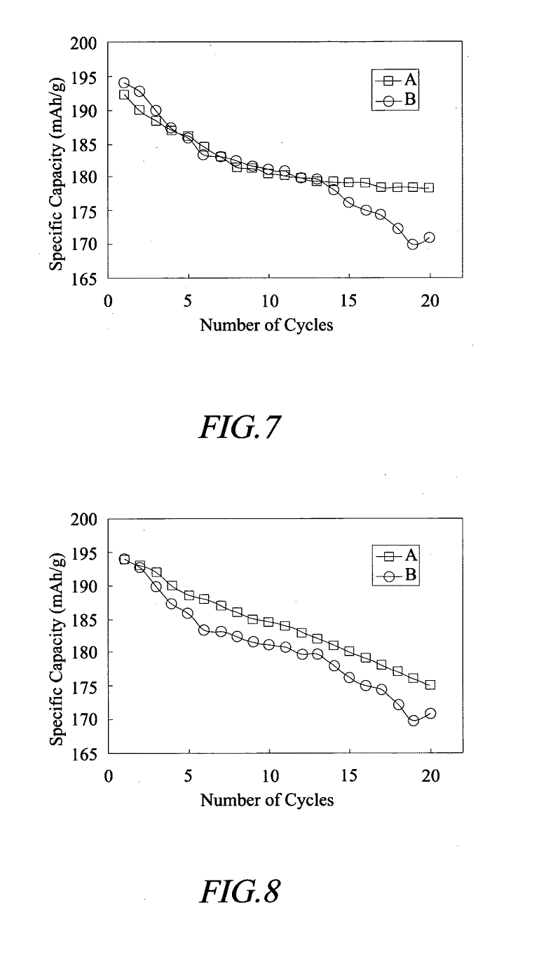

The coated positive active material is mixed with conductive carbon and polyvinylidene fluoride (“PVDF”) to produce positive slurry. The positive slurry is coated on a positive liquid collector to produce a positive electrode. A lithium plate is used as a negative electrode. The electrodes are assembled to produce a battery in a clean box. Referring to FIG. 7, at 3.0 to 4.3 volts, at 0.2 C, the discharge specific capacity of the LiNi_{0.8}Co_{0.2}O₂ is considerably increased after it is coated with TiOₙ.

In a fourth embodiment, 17.3 grams of SnCl₄ is dissolved in 0.5 litter of mixture of de-ionized water with ethanol. The ratio of the de-ionized water over the ethanol is 1:9. At the room temperature, the solution is stirred to expedite the dissolution. 500 grams of LiNi_{0.8}Co_{0.2}O₂ is added to the solution and the solution is stirred. 2M of aqua ammonia is dripped into the solution to adjust the pH value of the solution to 8, and the solution is stirred for 5 hours. The stirring is stopped before filtering and washing are executed. Drying is conducted at 85 degrees Celsius to produce a mixture. The mixture is sintered at 600 degrees Celsius for 2 hours before it is cooled at the room temperature. The coated positive active material is provided with a coating ratio of 2%.

The coated positive active material is mixed with conductive carbon and polyvinylidene fluoride (“PVDF”) to produce positive slurry. The positive slurry is coated on a positive liquid collector to produce a positive electrode. A lithium plate is used as a negative electrode. The electrodes are assembled to produce a battery in a clean box. Referring to FIG. 8, at 3.0 to 4.3 volts, at 0.2 C, the discharge specific capacity of the LiNi_{0.8}Co_{0.2}O₂ is increased after it is coated with SnOₙ.

In a fifth embodiment, 52 grams of Si(OC₂H₅)₄ is dissolved in 0.5 litter of ethanol solution. At the room temperature, the solution is stirred to expedite the dissolution. 500 grams of LiNi_{1/3}Co_{1/3}Mn_{1/3}O₂ is added to the solution and the solution is stirred for 5 hours. Then, the stirring is stopped, and filtering and washing are executed. Drying is conducted at 75 degrees Celsius to produce a mixture. The mixture is sintered at 500 degrees Celsius for 5 hours before it is cooled at the room temperature. The coated positive active material is provided with a coating ratio of 3%.

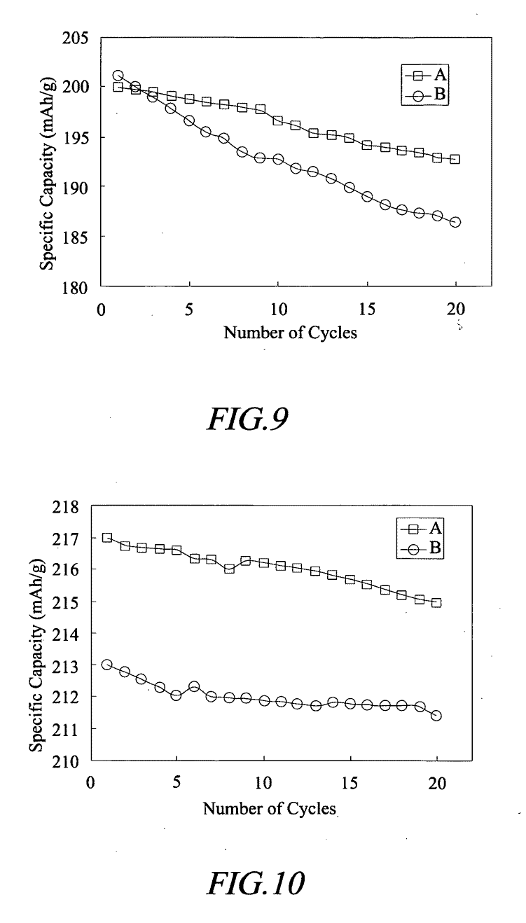

The coated positive active material is mixed with conductive carbon and polyvinylidene fluoride (“PVDF”) to produce positive slurry. The positive slurry is coated on a positive liquid collector to produce a positive electrode. A lithium plate is used as a negative electrode. The electrodes are assembled to produce a battery in a clean box. Referring to FIG. 9, at 3.0 to 4.5 volts, at 0.2 C, after 20 cycles, the discharge specific capacity of the LiNi_{1/3}Co_{1/3}Mn_{1/3}O₂ is increased by 6.3 mAh/g after it is coated with SiOₙ.

In a sixth embodiment, 49 grams of Mg(NO₃)₂.2H₂O is dissolved in 2 litters of de-ionized water. At the room temperature, the solution is stirred to expedite the dissolution. 500 grams of LiNi_{0.5}Co_{0.2}Mn_{0.3}O₂ is added to the solution and the solution is stirred. 2M of aqua ammonia is dripped into the solution to adjust the pH value of the solution to 7, and the solution is stirred for 5 hours. The stirring is stopped before filtering and washing are executed. Drying is conducted at 85 degrees Celsius to produce a mixture. The mixture is sintered at 600 degrees Celsius for 2 hours before it is cooled at the room temperature. The coated positive active material is provided with a coating ratio of 3%.

The coated positive active material is mixed with conductive carbon and polyvinylidene fluoride (“PVDF”) to produce positive slurry. The positive slurry is coated on a positive liquid collector to produce a positive electrode. A lithium plate is used as a negative electrode. The electrodes are assembled to produce a battery in a clean box. Referring to FIG. 10, at 3.0 to 4.5 volts, at 0.2 C, the discharge specific capacity of the LiNi_{0.5}Co_{0.2}Mn_{0.3}O₂ is increased by 2.5 mAh/g after it is coated with MgOₙ.

In a seventh embodiment, 13 grams of La(NO₃)₃.6H₂O is dissolved in 2 litters of mixture of de-ionized water with acetone. At the room temperature, the solution is stirred to expedite the dissolution. 500 grams of LiNi_{0.8}Co_{0.2}O₂ is added to the solution and the solution is stirred. 2M of aqua ammonia is dripped into the solution to adjust the pH value of the solution to 7, and the solution is stirred for 5 hours. The stirring is stopped before filtering and washing are executed. Drying is conducted at 85 degrees Celsius to produce a mixture. The mixture is sintered at 600 degrees Celsius for 2 hours before it is cooled at the room temperature. The coated positive active material is provided with a coating ratio of 1%.

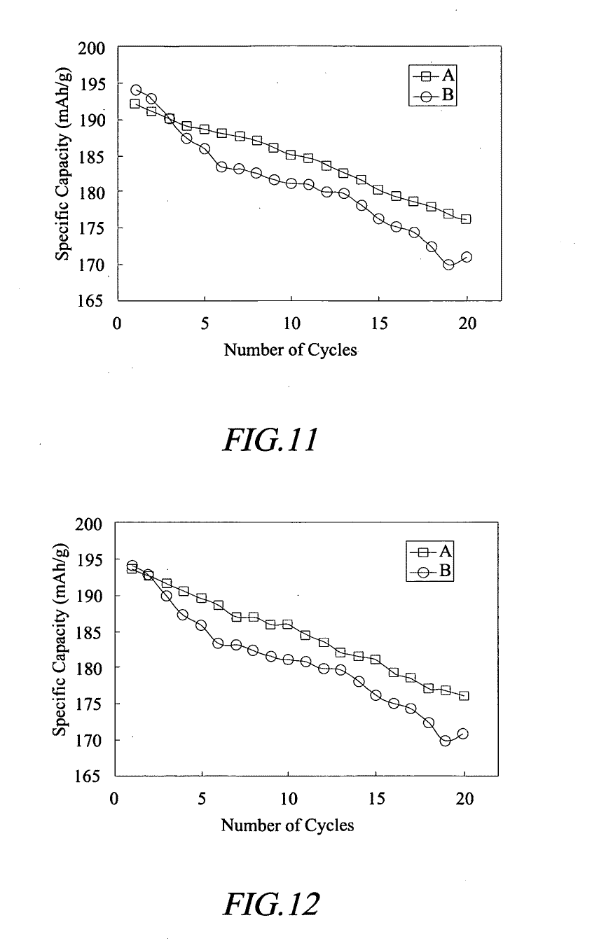

The coated positive active material is mixed with conductive carbon and polyvinylidene fluoride (“PVDF”) to produce positive slurry. The positive slurry is coated on a positive liquid collector to produce a positive electrode. A lithium plate is used as a negative electrode. The electrodes are assembled to produce a battery in a clean box. Referring to FIG. 11, at 3.0 to 4.3 volts, at 0.2 C, the discharge specific capacity of the LiNi_{0.8}Co_{0.2}O₂ is considerably increased after it is coated with LaOₙ.

In an eighth embodiment, 13 grams of Ce(NO₃)₃.6H₂O is dissolved in 2 litters of mixture of de-ionized water with acetone. At the room temperature, the solution is stirred to expedite the dissolution. 500 grams of LiNi_{0.8}Co_{0.2}O₂ is added to the solution and the solution is stirred. 2M of aqua ammonia is dripped into the solution to adjust the pH value of the solution to 7, and the solution is stirred for 5 hours. The stirring is stopped before filtering and washing are executed. Drying is conducted at 85 degrees Celsius to produce a mixture. The mixture is sintered at 600 degrees Celsius for 2 hours before it is cooled at the room temperature. The coated positive active material is provided with a coating ratio of 1%.

The coated positive active material is mixed with conductive carbon and polyvinylidene fluoride (“PVDF”) to produce positive slurry. The positive slurry is coated on a positive liquid collector to produce a positive electrode. A lithium plate is used as a negative electrode. The electrodes are assembled to produce a battery in a clean box. Referring to FIG. 12, at 3.0 to 4.3 volts, at 0.2 C, the discharge specific capacity of the LiNi_{0.8}Co_{0.2}O₂ is increased after it is coated with CeOₙ.

In a ninth embodiment, 160 grams of Al(CH₃COO)₃ is dissolved in 0.5 litter of mixture of de-ionized water with ethanol. The ratio of the de-ionized water over the ethanol is 1:1. At the room temperature, the solution is stirred to expedite the dissolution. 500 grams of LiCoO₂ is added to the solution and the solution is stirred for 5 hours. The stirring is stopped before filtering and washing are executed. Drying is conducted at 75 degrees Celsius to produce a mixture. The mixture is sintered at 500 degrees Celsius for 5 hours before it is cooled at the room temperature. The coated positive active material is provided with a coating ratio of 8%.

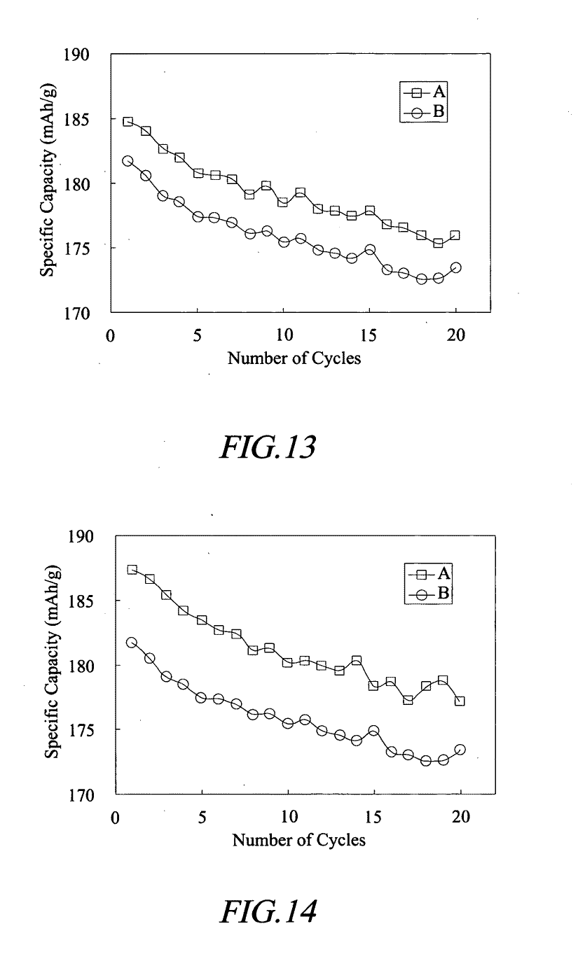

The coated positive active material is mixed with conductive carbon and polyvinylidene fluoride (“PVDF”) to produce positive slurry. The positive slurry is coated on a positive liquid collector to produce a positive electrode. A lithium plate is used as a negative electrode. The electrodes are assembled to produce a battery in a clean box. Referring to FIG. 13, at 3.0 to 4.5 volts, at 0.2 C, the discharge specific capacity of the LiCoO₂ is increased by 3.3 mAh/g after it is coated with AlOₙ.

In a tenth embodiment, 10.5 grams of ZrOCl₂.8H₂O is dissolved in 0.1 liter of water. 110.4 grams of Al(NO₃)₃.9H₂O is dissolved in 2 liters of de-ionized water completely. 500 grams of LiCoO₂ is added into the solution when the solution is stirred. The ZrOCl₂ solution is added into the solution. 5M of aqua ammonia is dripped into the solution to adjust the pH value of the solution to 6, and the solution is stirred for 5 hours. The stirring is stopped before filtering and washing are executed. Drying is conducted at 85 degrees Celsius to produce a mixture. The mixture is sintered at 500 degrees Celsius for 5 hours before it is cooled at the room temperature. The coated positive active material is provided with a coating ratio of 3.8%.

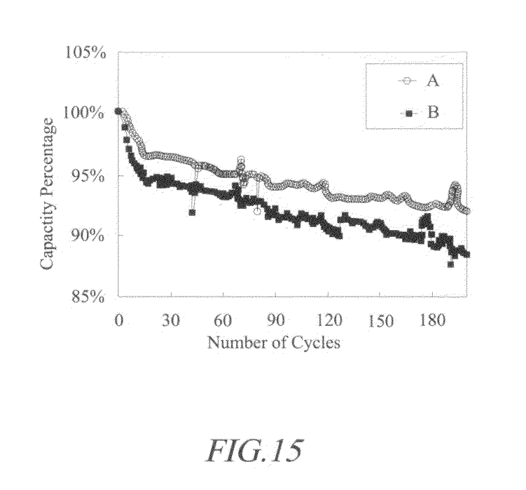

The coated positive active material is mixed with conductive carbon and polyvinylidene fluoride (“PVDF”) to produce positive slurry. The positive slurry is coated on a positive liquid collector to produce a positive electrode. A lithium plate is used as a negative electrode. The electrodes are assembled to produce a battery in a clean box. Referring to FIG. 14, at 3.0 to 4.5 volts, at 0.2 C, the discharge specific capacity of the LiCoO₂ is increased by 5.3 mAh/g after it is coated with AlZrOₙ.

In an eleventh embodiment, a positive active material is coated with another material to provide a coated positive active material. The coated positive active material is used as a positive electrode. Synthetic graphite is used as a negative electrode. The positive and negative electrodes and an isolating membrane are assembled, connected to terminals, wrapped with an aluminum foil, filled with liquid, packaged and vacuumed to provide a lithium-ion battery. Referring to FIG. 15, at 3.0 to 4.35 volts, at 0.2 C, after 200 cycles, the discharge specific capacity of the coated positive active material is reduced to 92% while the discharge specific capacity of a non-coated positive active material is reduced to 88%.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A method for coating a positive active material of a lithium-ion battery, the method comprising the steps:
dissolving at least one salt that contains a coating metal in a solvent to provide a solution;
dissolving a lithium-containing positive active material in the solution and adjusting the pH value of the solution, thus depositing M(OH)₂ₙ on the lithium-containing positive active material;
drying the M(OH)₂ₙ and the lithium-containing positive active material; and
sintering the M(OH)₂ₙ and the lithium-containing positive active material to coat the lithium-containing positive active material with MOₙ.

2. The method according to claim 1, wherein in the step of dissolving the salt in the solvent, the solvent is selected from a group consisting of water, an organic solvent that can be mixed with water, and mixture of organic solvents that can be mixed with water.

3. The method according to claim 2, wherein the solvent is an organic solvent that can be mixed with water, wherein the ratio of the weight of the organic solvent over the weight of the water is 0:1 to 100:1, wherein the weight of the solvent is 0.1 to 20 times as much as the weight of the salt.

4. The method according to claim 2, wherein the solvent is selected from a group consisting of alcohol and ketone.

5. The method according to claim 1, wherein the step of dissolving the salt in the solvent lasts for 0.5 to 1 hour at 0 to 100 degrees Celsius.

6. The method according to claim 1, wherein in the step of dissolving a lithium-containing positive active material in the solution and adjusting the pH value of the solution, the pH value is 3 to 12, wherein the deposition takes 1 to 20 hours.

7. The method according to claim 1, wherein in the step of drying the M(OH)₂ₙ and the lithium-containing positive active material, the temperature is 50 to 200 degrees Celsius, wherein the drying takes 1 to 20 hours.

8. The method according to claim 1, wherein in the step of sintering the M(OH)₂ₙ and the lithium-containing positive active material, the sintering is executed at 300 to 1300 degrees Celsius, wherein the sintering takes 1 to 20 hours.

9. The method according to claim 1, including the step of using the solvent to wash the lithium-containing positive active material to which the M(OH)₂ₙ is adhered before the step of drying the M(OH)₂ₙ and the lithium-containing positive active material.

10. The method according to claim 1, wherein the lithium-containing positive active material is LiCo_{1-x-y}M′ₓM″_{y}O₂, wherein M′ and M″ are selected from a group consisting of Al, Ce, Ga, Ge, La, Mg, Mn, Ni, Si, Sn, Ti, W and Zn, wherein 0≦x<1, and 0≦y<1.

11. The method according to claim 1, wherein in the step of sintering the M(OH)₂ₙ and the lithium-containing positive active material to coat the lithium-containing positive active material with MOₙ, the M of the MOₙ is selected from a group consisting of Al, Ce, La, Mg, Si, Sn, Ti, Zn and Zr.

12. The method according to claim 1, wherein the salt that contains the coating metal is selected from a group consisting of non-organic salts, alcohols and organic salts.

13. The method according to claim 1, wherein the ratio of the weight of the salt that contains the coating material over the weight of the lithium-containing positive active material is 0.1% to 60%.

14. A material for coating a positive active material of a lithium-ion battery made according to claims 1 to 13.

15. A lithium-ion battery including a positive electrode, a negative electrode, an isolating membrane provided between the positive and negative electrodes, and electrolyte, wherein the positive electrode is made by mixing conductive carbon powder and adhesive with the positive active material according to claim 14.
